(19) United States
(12) Patent Application Publication
(10) Pub. No.: US 2014/0216410 A1
(43) Pub. Date: Aug. 7, 2014

(54) FUEL INJECTION SYSTEM FOR COMPRESSION-IGNITION ENGINE

(71) Applicant: Caterpillar Inc., Peoria, IL (US)

(72) Inventors: Tian Ye, Bloomington, IL (US); Jiubo Ma, Suzhou (CN)

(73) Assignee: Caterpillar Inc., Peoria, IL (US)

(21) Appl. No.: 14/245,061

(22) Filed: Apr. 4, 2014

(51) Int. Cl. F02D 41/38

(52) U.S. Cl. CPC F02D 41/3809
USPC 123/456

(57) ABSTRACT

A fuel injection system for a fuel system of a compression-ignition engine is disclosed. In the current disclosure, the fuel injection system includes a common rail, at least one control valve, and a controller. The common rail may be configured to receive fuel from a fuel pump of the fuel system. The at least one control valve may be in fluid communication with the common rail and at least one fuel nozzle of the fuel system. The at least one control valve may be configured to receive fuel from the common rail. Further, the at least one control valve may be configured to supply fuel to the at least one fuel nozzle. The controller may be configured to control the at least one control valve.

### TECHNICAL FIELD

The present disclosure relates generally relates to a fuel system of a compression engine. More specifically, the present disclosure relates to a fuel injection system for the fuel system of the compression engine.

### BACKGROUND

Mobile machines, such as cars, buses, earth moving and mining machines, etc., include power sources, such as compression-ignition engines. The compression-ignition engines use the heat of compression to ignite and burn fuel, such as diesel fuel. Hereinafter the compression-ignition engine will be referred as compression engine. In some machines, fuel may be provided to the compression engine by a pump-line-nozzle system. Pump-line-nozzle system is old and well known in the art. The pump-line-nozzle system may include inline pumps Inline pumps have a separate pumping chamber for supplying fuel to each fuel nozzle of the pump-line-nozzle system. The pump-line-nozzle system can be used with a multi-cylinder compression engine as well by using a rack and a cam. The rack and the cam may be used to control the fuel delivery and to ensure that the fuel delivery is the same for all cylinders of the multi-cylinder compression engine.

With the advancement of technology, a common rail fuel system came into existence. The common rail fuel system comprises a fuel pump, a high-pressure pump, a common rail and at least one fuel nozzle. The fuel pump may be configured to have a fluid communication with the high-pressure pump. The high-pressure pump may further be configured to have a fluid communication with the common rail. The common rail may be in fluid communication with the at least one fuel nozzle. The fuel pump delivers fuel from a fuel supply to the high-pressure pump through a conduit, wherein the conduit may host an inlet metering valve. The high-pressure pump pressurizes fuel for delivery through the common rail. Fuel travels through the common rail to the at least one fuel nozzle, and ultimately to at least one engine cylinder. Within the at least one engine cylinder, fuel is burned to provide power to the vehicles.

However, retrofitting a fuel injection system from the pump-line-nozzle system to the common rail fuel system may face several challenges. Examples of these challenges may include, but not limited to, changes in the structure of the compression engine, high cost, and/or time involved in changing the structure of the compression engine.

Various solutions have been developed to address the challenges cited above. The present disclosure is directed towards overcoming the above-stated challenges.

### SUMMARY OF THE DISCLOSURE

In the current disclosure, a fuel injection system for a fuel system of a compression engine is disclosed. The fuel system may include a fuel tank, a fuel pump and at least one fuel nozzle. The fuel pump may be configured to supply fuel from the fuel tank to the at least one fuel nozzle. Further, the at least one fuel nozzle may be configured to inject fuel in a combustion chamber of the compression engine. The fuel injection system may include a common rail, at least one control valve and a controller. The common rail may be configured to receive fuel from the fuel pump. The at least one control valve may be in fluid communication with the fuel pump and the at least one fuel nozzle. The at least one control valve may be configured to receive fuel from the common rail. The at least one control valve may further be configured to supply fuel to the at least one fuel nozzle. The controller may be configured to control the at least one control valve. The controller may control the at least one control valve to inject fuel in the combustion chamber using the at least one fuel nozzle.

Other features and advantages of the disclosure will become apparent to those skilled in the art, upon review of the following detailed description and drawings.

### BRIEF DESCRIPTION OF DRAWINGS

FIG. 1 illustrates a schematic view of a fuel injection system, in accordance to the concepts of the present disclosure;

FIG. 2 illustrates a perspective view of a common rail, in accordance to the concepts of the present disclosure; and

FIG. 3 illustrates a sectional view of a control valve, in accordance to the concepts of the present disclosure.

### DETAILED DESCRIPTION

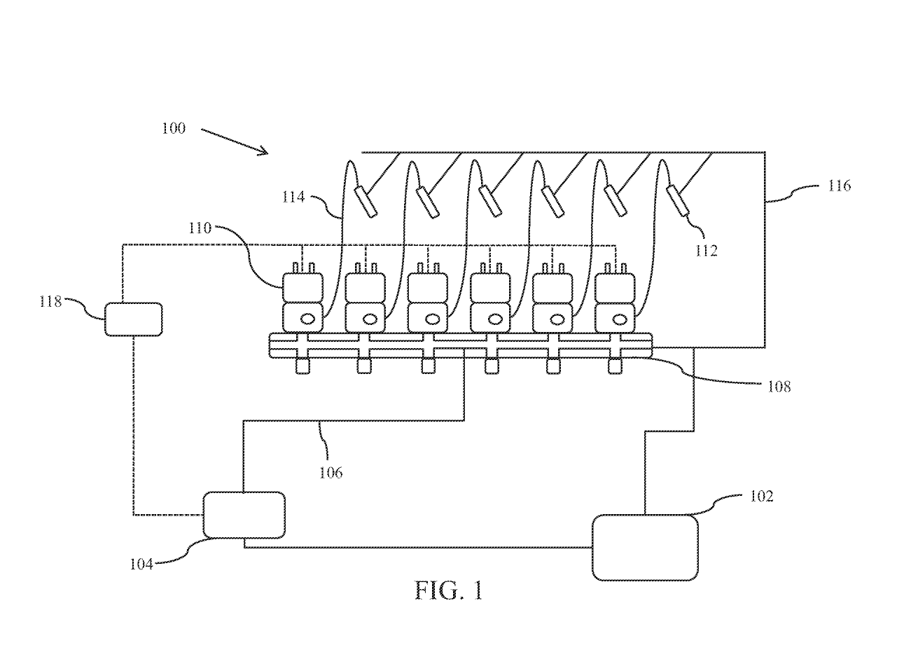

FIG. 1 illustrates a schematic view of a fuel injection system 100, in accordance to the concepts of the present disclosure. The fuel injection system 100 may be configured to convert a pump-line-nozzle system to a common rail fuel system for a compression engine. The fuel injection system 100 includes a fuel tank 102, a fuel pump 104, a primary duct 106, a common rail 108, at least one control valve 110, at least one fuel nozzle 112, a secondary duct 114, a return duct 116, and a controller 118.

The fuel tank 102 of the fuel injection system 100 may be configured to store the fuel required for operating the compression engine. The fuel stored may be supplied from the fuel tank 102 using the fuel pump 104.

The fuel pump 104 of the fuel injection system 100 may be configured to supply fuel from the fuel tank 102. The fuel pump 104 may be a mechanical pump, an electrical pump, a hydraulic pump, a turbo pump, a gear-type pump, a plunger-type pump, and/or a vane-type pump. However, it is evident to a person with ordinary skill in the art that the type of fuel pump 104 used nowhere limits the idea disclosed. The fuel pump 104 may be configured to supply the fuel at a desired pressure. In an embodiment, the fuel pump 104 may be in fluid communication with a filter, a secondary pump or the like. The fuel pump 104 may further be configured to supply fuel to the primary duct 106.

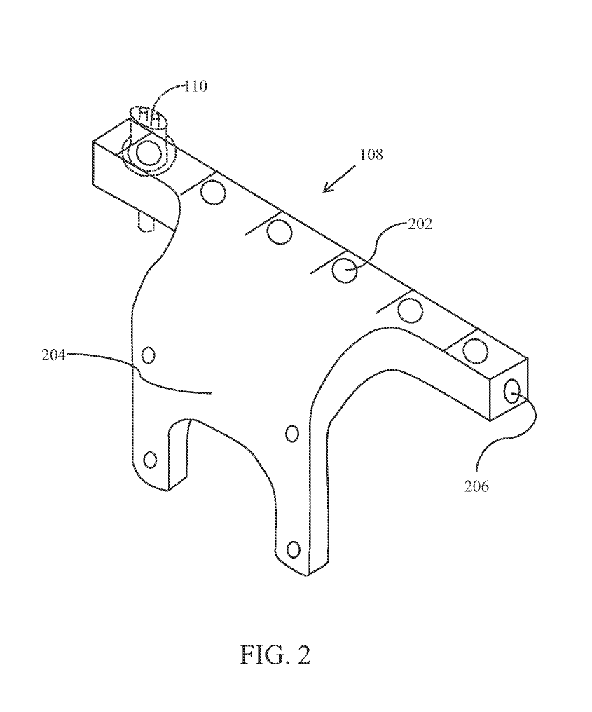

The primary duct 106 may be in fluid communication with the common rail 108. The primary duct 106 may be configured to supply fuel at the desired pressure from the fuel pump 104 to the common rail 108. The common rail 108 may further be configured to supply the fuel for operating the compression engine. The common rail 108 is discussed later in the disclosure with reference to FIG. 2.

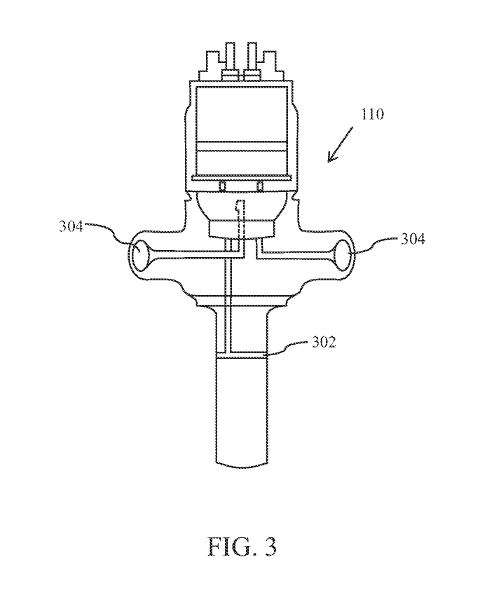

The common rail 108 may be equipped with the at least one control valve 110. However, it is evident to a person with the ordinary skills in the art that the at least one control valve 110 may be directly coupled with the common rail 108 or may be coupled using an extension with the common rail 108. The coupling method of the at least one control valve 110 with the common rail 108 nowhere effects the functionality of the idea disclosed. The at least one control valve 110 may be configured to control the flow of the high-pressure fuel from the common rail 108. The at least one control valve 110 is discussed later in the disclosure with reference to FIG. 3. The at least one control valve 110 may be in fluid communication with the at least one fuel nozzle 112 using the secondary duct 114.

The at least one fuel nozzle 112 may be configured to inject fuel into a combustion chamber of the compression engine. In an embodiment, the at least one fuel nozzle 112 may be a part of the pump-line-nozzle system which may required to be converted into the common rail fuel system. In an embodiment, the at least one fuel nozzle 112 may be in fluid communication with the return duct 116. The return duct 116 may be configured to carry the excess fuel or the fuel used for cooling the at least one fuel nozzle 112 to the fuel tank 102.

The controller 118 of the fuel injection system 100 may be configured to regulate the at least one control valve 110 of the fuel injection system 100. The controller 118 may regulate the fuel flow within the at least one control valve 110. The controller 118 may further control the injection of fuel within the combustion chamber based on the operational condition and requirement of the compression engine.

FIG. 2 illustrates a perspective view of the common rail 108, in accordance to the concepts of the present disclosure. The common rail 108 is a distribution device that retains the high-pressure fuel pumped by the high-pressure pump 108 within a distribution channel 206 running along the length of the common rail 108. The retained fuel in the common rail 108 may be discharged through a mounting hole 202 and is supplied further to the at least one fuel nozzle 112. In an embodiment the at least one control valve 110 may be coupled with the common rail 108 using the mounting hole 202. The number of mounting holes 202 in the common rail 108 depends on the number of combustion chambers in the compression engine. However, it should be evident to the person with ordinary skill in the art that the number of mounting holes 202 or shape or length of the common rail 108 in no way affects the scope of the idea disclosed. In an embodiment, the common rail 108 may include a bracket 204. The bracket 204 may be configured to mount the fuel injection system 100 over the compression engine.

FIG. 3 illustrates a sectional view of the at least one control valve 110, in accordance to the concepts of the present disclosure. In reference to FIG. 3, the at least one control valve 110 may be a three way valve, which may include one inlet port 302 and two outlet ports 304. The three way valve may use electric current to actuate or shift a valve between open and close position to control the flow of fuel. The flow of fuel may be regulated between the one inlet port 302 and the two outlet ports 304. The manipulation of flow between the three ports of the at least one control valve 110 may be based on the requirement of fuel in the combustion chamber and operational conditions of the compression engine.

### INDUSTRIAL APPLICABILITY

In operation, the fuel injection system 100 may be installed to convert the pump-line-nozzle system into the common rail fuel system for the compression engine. During the operation, the fuel injection system 100 is assembled over the compression engine. The fuel injection system 100 includes the fuel tank 102, the fuel pump 104, the primary duct 106, the common rail 108, the at least one control valve 110, the at least one fuel nozzle 112, the secondary duct 114, the return duct 116 and the controller 118. In an embodiment, the fuel tank 102 and the at least one fuel nozzle 112 may be a part of the pump-line-nozzle system, which may be converted into the common rail fuel system.

The fuel pump 104 may be installed in fluid communication with the fuel tank 102. The fuel pump 104 may then operate to supply fuel from the fuel tank 102, at the desired pressure. The fuel pump 104 may then supply the fuel to the common rail 108, using the primary duct 106. The common rail 108 may then retain the fuel at the desired pressure within the distribution channel 206. The common rail 108 may further distribute the fuel through the mounting hole 202. The mounting hole 202 may be equipped with the at least one control valve 110. The at least one control valve 110 may then operate to control the flow of the high pressure fuel. The at least one control valve 110 may further direct the fuel to the at least one fuel nozzle 112 using the secondary duct 114. The fuel may be directed towards the at least one fuel nozzle 112 when the fuel is required in the combustion chamber for the compression engine to operate. The at least one fuel nozzle 112 may be in fluid communication with the return duct 116. The return duct 116 may be configured to carry the excess fuel or the fuel used for cooling the at least one fuel nozzle 112 to the fuel tank 102. The controller 118 may further regulate the operations of the at least one control valve 110, for efficient operation of the fuel injection system 100.

The current disclosure provides a fuel injection system 100, which may be configured to transform the pump-line-nozzle system into the common rail fuel system for the compression engine. The fuel injection system 100 disclosed is easy to install, requires very few structural changes in the compression engine, thus reducing the overall cost and time involved in the transformation of the fuel injection system from the pump-line-nozzle system to the common rail fuel system.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A fuel injection system for a fuel system of a compression engine wherein the fuel system comprising a fuel tank, a fuel pump, and at least one fuel nozzle, wherein the fuel pump is configured to supply fuel from the fuel tank and the at least one fuel nozzle is configured to inject fuel in a combustion chamber of the compression engine, the fuel injection system comprises:
a common rail configured to receive fuel from the fuel pump;
at least one control valve in fluid communication with the common rail and the at least one fuel nozzle, wherein the at least one control valve is configured to receive fuel from the common rail, wherein the control valve configured to supply the fuel to the at least one fuel nozzle; and
a controller configured to control the at least one control valve wherein the at least one control valve is controlled to inject fuel in the combustion chamber via the at least one fuel nozzle.
